(19) United States
(12) Patent Application Publication
(10) Pub. No.: US 2023/0333202 A1
(43) Pub. Date: Oct. 19, 2023

(54) WIRELESS POWER RECEPTION DEVICE DISPLAYING WIRELESS CHARGING RANGE, AND OPERATING METHOD THEREOF

(71) Applicant: SAMSUNG ELECTRONICS CO., LTD., Suwon-si (KR)

(72) Inventors: Beomwoo GU, Suwon-si (KR); Jaehyun PARK, Suwon-si (KR); Hyunseok SHIN, Suwon-si (KR); Jeongman LEE, Suwon-si (KR); Chongmin LEE, Suwon-si (KR); Bohwan CHOI, Suwon-si (KR); Hyoseok HAN, Suwon-si (KR)

(21) Appl. No.: 18/338,897

(22) Filed: Jun. 21, 2023

Related U.S. Application Data
(63) Continuation of application No. PCT/KR2021/018199, filed on Dec. 3, 2021.

(30) Foreign Application Priority Data
Feb. 1, 2021 (KR) 10-2021-0014012

(51) Int. Cl. G01S 5/02; H02J 50/90; H02J 50/80; H02J 50/12

(52) U.S. Cl. CPC G01S 5/0284; H02J 50/90; H02J 50/80; H02J 50/12

(57) ABSTRACT

According to various embodiments, a method of operating a wireless power reception device may comprise: confirming information about the location of the wireless power reception device with respect to a wireless power transmission device based on a first signal received from the wireless power transmission device using at least one communication module of the wireless power reception device; confirming information about a first charging range of the wireless power transmission device based on a second signal received from the wireless power transmission device using the at least one communication module; and displaying the location of the wireless power reception device as a first icon and the first charging range as a line or a plane on a display of the wireless power reception device based on the information about the location of the wireless power reception device and the information about the first charging range of the wireless power transmission device.

### CROSS-REFERENCE TO RELATED APPLICATIONS

This application is a continuation of International Application No. PCT/KR2021/018199 designating the United States, filed on Dec. 3, 2021, in the Korean Intellectual Property Receiving Office and claiming priority to Korean Patent Application No. 10-2021-0014012, filed on Feb. 1, 2021, in the Korean Intellectual Property Office, the disclosures of which are incorporated by reference herein in their entireties.

### BACKGROUND

### Field

The disclosure relates to a wireless power reception device displaying a wireless charging range and an operating method thereof.

### Description of Related Art

In a wireless power transmission system, a charging range of a wireless power transmission device may refer to a range for charging a different electronic device with wireless power transmitted by the wireless power transmission device. The charging range of the wireless power transmission device may be changed based on the level of charging power of the wireless power transmission device, a charging environment, the type of a wireless power reception device, or the number of wireless power reception devices charged by one wireless power transmission device.

Unlike a wired power reception device, a wireless power reception device may achieve constant charging efficiency when located within the charging range of the wireless power transmission device. When the wireless power reception device is located outside the charging range of the wireless power transmission device, the charging efficiency of the wireless power reception device may be reduced.

When a user of a wireless power reception device does not recognize a charging range of a wireless power transmission device, there is a possibility of placing the wireless power reception device outside the charging range of the wireless power transmission device, and thus charging efficiency of the wireless power reception device may be reduced.

### SUMMARY

Embodiments of the disclosure provide a wireless power reception device displaying a wireless charging range and an operating method thereof that may enable a user to recognize a charging range of a wireless power transmission device.

According to various example embodiments, a method of operating a wireless power reception device may include: identifying information about a location of the wireless power reception device based on a wireless power transmission device, based on a first signal received from the wireless power transmission device using at least one communication module including communication circuitry of the wireless power reception device, identifying information about a first charging range of the wireless power transmission device, based on a second signal received from the wireless power transmission device using the at least one communication module, and displaying the location of the wireless power reception device in a first icon and displaying the first charging range in a line or a face on a display of the wireless power reception device, based on the information about the location of the wireless power reception device and the information about the first charging range of the wireless power transmission device.

According to various example embodiments, a wireless power reception device may include: a display, at least one communication module comprising communication circuitry, and a processor, wherein the processor may be configured to: identify information about a location of the wireless power reception device based on a wireless power transmission device, based on a first signal received from the wireless power transmission device using the at least one communication module, identify information about a first charging range of the wireless power transmission device, based on a second signal received from the wireless power transmission device using the at least one communication module, and control the display to display the location of the wireless power reception device in a first icon and displaying the first charging range in a line or a face, based on the information about the location of the wireless power reception device and the information about the first charging range of the wireless power transmission device.

According to various example embodiments, a wireless power reception device displaying a wireless charging range and an operating method thereof may be provided. A charging range of a wireless power transmission device may be displayed on a display of the wireless power reception device, thereby enabling a user to recognize the charging range of the wireless power transmission device and thus improving charging efficiency of the wireless power reception device.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments;

FIG. 2A is a signal flow diagram illustrating an example distance measurement process based on UWB communication according to various embodiments;

FIG. 2B is a signal flow diagram illustrating an example distance measurement process based on UWB communication according to various embodiments;

FIG. 2C is a diagram illustrating an example direction measurement process based on reception of a UWB signal according to various embodiments;

FIG. 3 is a block diagram illustrating an example configuration of a first electronic device and a second electronic device according to various embodiments;

FIG. 4A is a diagram illustrating transmission/reception of a communication signal in each antenna of a second communication module according to various embodiments;

FIG. 4B is a diagram illustrating orientation measurement of a sensor module according to various embodiments;

FIG. 5 is a diagram illustrating a charging range of a wireless power transmission device in a wireless power transmission system according to various embodiments;

FIG. 6 is a flowchart illustrating an example method of operating a wireless power reception device according to various embodiments;

FIG. 7A is a flowchart illustrating an example method of operating a wireless power reception device according to various embodiments;

FIG. 7B is a diagram illustrating a display of a display of a wireless power reception device according to various embodiments;

FIG. 8 is a flowchart illustrating an example method of operating a wireless power reception device according to various embodiments;

FIG. 9A is a diagram illustrating a display of a display of a wireless power reception device according to various embodiments;

FIG. 9B is a diagram illustrating a display of a display of a wireless power reception device according to various embodiments;

FIG. 9C is a diagram illustrating a display of a display of a wireless power reception device according to various embodiments

FIG. 10 is a flowchart illustrating an example method of operating a wireless power reception device according to various embodiments;

FIG. 11A is a diagram illustrating a display of a display of a wireless power reception device according to various embodiments;

FIG. 11B is a diagram illustrating a display of a display of a wireless power reception device according to various embodiments;

FIG. 12 is a flowchart illustrating an example method of operating a wireless power reception device according to various embodiments;

FIG. 13A is a diagram illustrating a display of a display of a wireless power reception device according to various embodiments;

FIG. 13B is a diagram illustrating a display of a display of a wireless power reception device according to various embodiments;

FIG. 13C is a diagram illustrating a display of a display of a wireless power reception device according to various embodiments;

FIG. 14 is a flowchart illustrating an example method of operating a wireless power reception device according to various embodiments; and

FIG. 15 is a diagram illustrating a display of a display of a wireless power reception device according to various embodiments.

### DETAILED DESCRIPTION

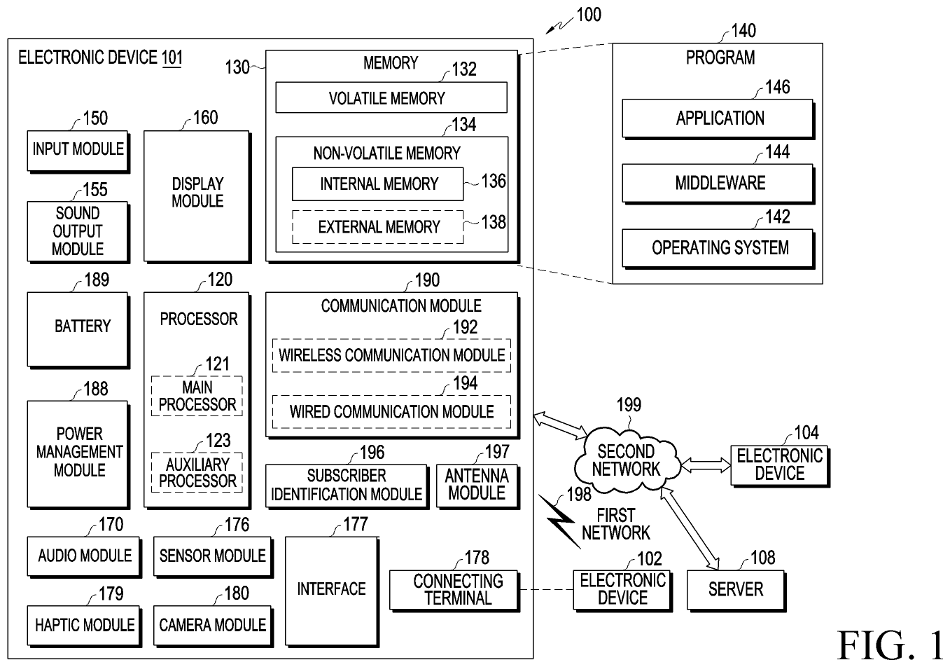

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network).

According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images.

According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of lms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

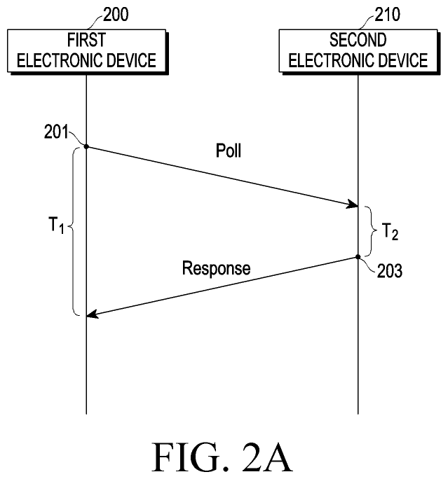

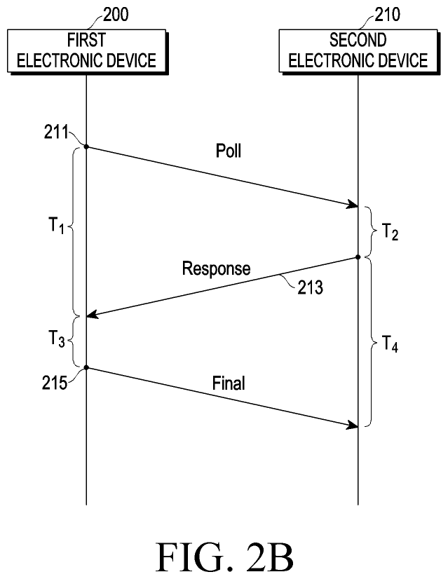

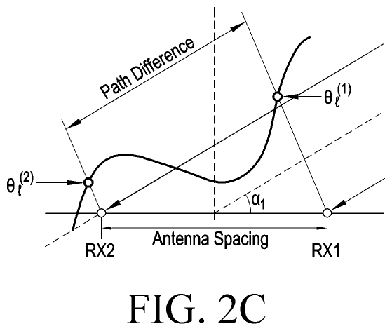

FIG. 2A and FIG. 2B are signal flow diagrams illustrating example distance measurement processes based on UWB communication according to various embodiments.

A first electronic device 200 and a second electronic device 210 illustrated in FIG. 2A and FIG. 2B are electronic devices supporting UWB communication, and types thereof are not limited. For example, the first electronic device 200 and/or the second electronic device 210 may be the same type of electronic device as the electronic device 101 of FIG. 1, and a description of the electronic device 101 of FIG. 1 may be applied to the first electronic device 200 and/or the second electronic device 210 within a necessary range. Hereinafter, regarding a description of operations of the first electronic device 200 and the second electronic device 210 using UWB, those skilled in the art will understand that an operation described as an operation of the second electronic device 210 may be performed by the first electronic device 200 and an operation described as an operation of the first electronic device 200 may be performed by the second electronic device 210.

Referring to FIG. 2A, the first electronic device 200 (e.g., a processor (e.g., 120 of FIG. 1) of the first electronic device 200 and/or a communication module (e.g., 190 of FIG. 1) of the first electronic device 200) according to various embodiments may identify a distance to the second electronic device 210, based on a single-sided two-way ranging (SS-TWR) method. In operation 201, the first electronic device 200 may transmit a poll message (e.g., ranging poll). For example, the communication module (e.g., 190 of FIG. 1) of the first electronic device 200 may include a UWB communication module, and the UWB communication module may transmit the poll message. The second electronic device 210 (e.g., a processor (e.g., 120 of FIG. 1) of the second electronic device 210 and/or a communication module (e.g., 190 of FIG. 1) of the second electronic device 210) may receive a poll message, and may transmit a response message (e.g., ranging response) in response in operation 203. For example, the communication module (e.g., 190 of FIG. 1) of the second electronic device 210 may include a UWB communication module, and the UWB communication module may transmit the response message. To receive the poll message and transmit the response message in response to the poll message, the second electronic device 210 may consume a second time T2, and the second time may be referred to as, for example, a process time.

The second electronic device 210 may transmit the response message including information including the process time, for example, the second time T2, to the first electronic device 200.

The second electronic device 210 according to various embodiments may identify the distance between the first electronic device 200 and the second electronic device 210, based on a time when the poll message is transmitted, a time when the response message is received, and the process time (e.g., the second time T2) included in the response message. For example, when a difference between the time when the poll message is transmitted and the time when the response message is received is a first time T1, the first electronic device 200 may identify (T1-T2)*c/2 (where c is a speed of light) as the distance between the first electronic device 200 and the second electronic device 210.

Referring to FIG. 2B, the first electronic device 200 (e.g., the processor (e.g., 120 of FIG. 1) of the first electronic device 200 and/or the communication module (e.g., 190 of FIG. 1) of the first electronic device 200) according to various embodiments may identify a distance to the second electronic device 210, based on a double-sided two-way ranging (DS-TWR) method. In operation 211, the first electronic device 200 may transmit a poll message. For example, the communication module (e.g., 190 of FIG. 1) of the first electronic device 200 may include a UWB communication module, and the UWB communication module may transmit the poll message. The second electronic device 210 (e.g., the processor (e.g., 120 of FIG. 1) of the second electronic device 210 and/or the communication module (e.g., 190 of FIG. 1) of the second electronic device 210) may receive a poll message, and may transmit a response message in response in operation 213. For example, the communication module (e.g., 190 of FIG. 1) of the second electronic device 210 may include a UWB communication module, and the UWB communication module may transmit the response message. To receive the poll message and transmit the response message in response to the poll message, the second electronic device 210 may consume a process time of a second time T2. The second electronic device 210 may transmit the response message including information including the process time, for example, the second time T2, to the first electronic device 200.

According to various embodiments, in operation 215, the first electronic device 200 may transmit a final message (e.g., ranging final), based on reception of the response message. For example, to receive the response message and transmit the final message in response to the response message, the first electronic device 200 may consume a process time of a third time T3. The first electronic device 200 may transmit the final message including information including the process time, for example, the third time T3, to the second electronic device 210.

The first electronic device 200 according to various embodiments may identify the distance between the first electronic device 200 and the second electronic device 210, based on a time when the poll message is transmitted, a time when the response message is received, and the process time (e.g., the second time T2) included in the response message. The second electronic device 210 according to various embodiments may identify the distance between the first electronic device 200 and the second electronic device 210, based on a time when the response message is transmitted, a time when the final message is received, and the process time (e.g., the third time T3) included in the final message. For example, when a difference between the time when the response message is transmitted and the time when the final message is received is a fourth time T4, the second electronic device 210 may identify (T4-T3)*c/2 (where c is the speed of light) as the distance between the first electronic device 200 and the second electronic device 210.

FIG. 2C is a diagram illustrating an example direction measurement process based on reception of a UWB signal according to various embodiments.

Hereinafter, a direction measurement process based on reception of a UWB signal is described from a viewpoint of the first electronic device 200 with reference to FIG. 2C, but those skilled in the art will understand that this description is also applicable to a direction measurement process based on reception of a UWB signal from a viewpoint of the second electronic device 210.

Referring to FIG. 2C, the first electronic device 200 (e.g., the processor (e.g., 120 of FIG. 1) of the first electronic device 200 and/or the communication module (e.g., 190 of FIG. 1) of the first electronic device 200) according to various embodiments may identify a direction of the second electronic device 210 based on the first electronic device 200, based on an angle-of-arrival (AOA) method. For example, the communication module (e.g., 190 of FIG. 1) (e.g., a UWB communication module) of the first electronic device 200 may support two reception antennas RX1 and RX2. The two reception antennas RX1 and RX2 may be disposed at an antenna spacing. The second electronic device 210 is assumed to be located in a direction of an angle α1 with respect to the first electronic device 200. The antenna spacing causes a difference between signal reception times in the respective reception antennas RX1 and RX2 and a phase difference between signals. For example, a signal received by a first reception antenna RX1 may have a phase of θ1(1), and a signal received by a second reception antenna RX2 may have a phase of θ1(2). The first electronic device 200 may identify the angle α1 at which the second electronic device 210 is located, based on the phase difference between the phases measured in the respective two reception antennas RX1 and RX2 (or the difference between the reception times measured in the two receiving antennas) and the antenna spacing.

According to various embodiments, the first electronic device 200 may identify a first angle, which is the direction in which the second electronic device 210 is located based on the first electronic device 200, based on a measurement result in the two reception antennas RX1 and RX2. According to various embodiments, the first electronic device 200 may include three or more reception antennas. The first electronic device 200 may identify a first angle, which is the direction in which the second electronic device 210 is located based on the first electronic device 200, based on a measurement result in a first combination of two reception antennas, and may identify a second angle, which is the direction in which the second electronic device 210 is located based on the first electronic device 200, based on a measurement result in a second combination of two reception antennas.

As described above, the first electronic device 200 may identify the distance to the second electronic device 210 and/or the direction of the second electronic device 210. Further, as described above, the second electronic device 210 may identify the distance to the first electronic device 200 and/or the direction of the first electronic device 200, and a redundant description will be omitted.

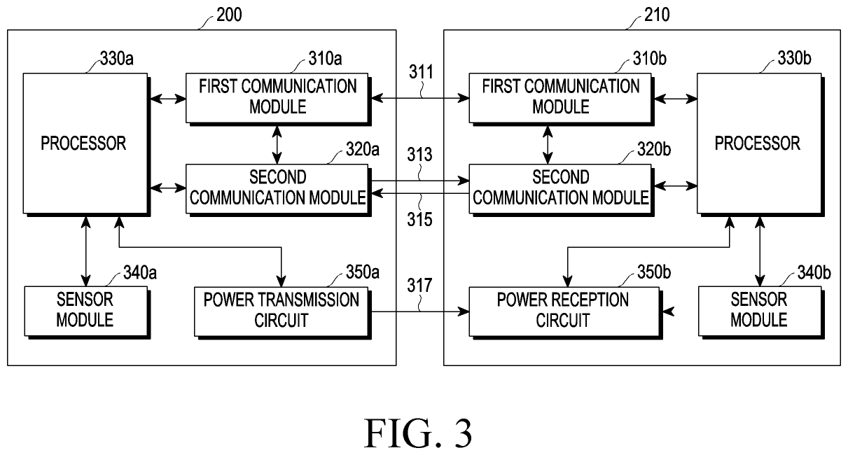

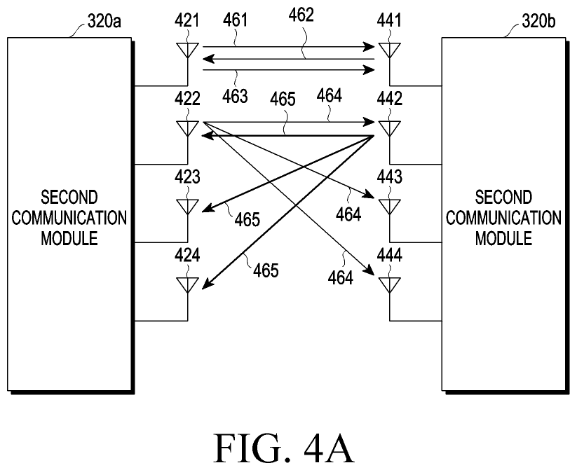

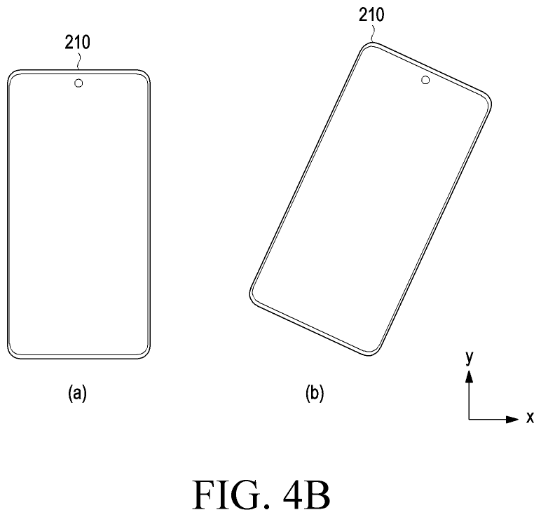

FIG. 3 is a block diagram illustrating an example configuration of a first electronic device and a second electronic device according to various embodiments. The embodiments of FIG. 3 will be described with reference to FIG. 4A and FIG. 4B. FIG. 4A is a diagram illustrating transmission/reception of a communication signal in each antenna of a second communication module according to various embodiments. FIG. 4B is a diagram illustrating orientation measurement of a sensor module according to various embodiments.

Referring to FIG. 3, the first electronic device 200 according to various embodiments may include at least one of a processor (e.g., including processing circuitry) 330a, a sensor module (e.g., including at least one sensor) 340a, a first communication module (e.g., including communication circuitry) 310a, a second communication module (e.g., including communication circuitry) 320a, and/or a power transmission circuit 350a. The first electronic device 200 may be understood as a wireless power transmission device 200. The second electronic device 210 may include at least one of a first communication module (e.g., including communication circuitry) 310b, a second communication module (e.g., including communication circuitry) 320b, a processor (e.g., including processing circuitry) 330b, a sensor module (e.g., including at least one sensor) 340b, and/or a power reception circuit 350b. The second electronic device 210 may be understood as a wireless power reception device 210, and the first electronic device 200 and/or the second electronic device 210 may be configured as the electronic device 101 of FIG. 1. The first communication module 310a of the first electronic device 200 and the first communication module 310b of the second electronic device 210 may support a first communication method. The second communication module 320a of the first electronic device 200 and the second communication module 320b of the second electronic device 210 may support a second communication method. The second communication method may be a communication method for identifying, for example, a location of the second electronic device 210 (e.g., a distance from the first electronic device 200 to the second electronic device 210 and/or a direction of the second electronic device 210 based on the first electronic device 200) and/or a location of the first electronic device 200 (e.g., a distance from the second electronic device 210 to the first electronic device 200 and/or a direction of the first electronic device 200 based on the second electronic device 210), and may be UWB communication, without being limited thereto. The first communication method may be, for example, a Bluetooth (or Bluetooth Low Energy (BLE)) communication method, but is not limited to a specific communication method as long as the first communication method is different from the second communication method. For example, the first communication method may be a Zigbee, Wi-Fi, and/or near field communication (NFC) communication method, and the type thereof is not limited.

According to various embodiments, the first communication module 310a may include various communication circuitry and establish a communication connection 311 with the first communication module 310b, based on the first communication method. For example, when the first communication method is BLE communication, the first communication module 310a and the first communication module 310b may establish a BLE connection. The BLE connection may be established, for example, based on signal transmission/reception between the first communication module 310a and the first communication module 310b, but is not limited thereto.

According to various embodiments, the sensor module 340a may include various sensors and sense at least one piece of data for identifying an orientation of the first electronic device 200. The processor 330a may identify the orientation of the first electronic device 200, based on the at least one piece of data from the sensor module 340a. The sensor module 340b may sense at least one piece of data for identifying an orientation of the second electronic device 210. The processor 330b may identify the orientation of the second electronic device 210, based on the at least one piece of data from the sensor module 340b. The sensor module 340a and/or the sensor module 340b may include, for example, an acceleration sensor, a gyro sensor, and/or a geomagnetic sensor, but the type of the sensors is not limited. The orientation of the first electronic device 200 and/or the orientation of the second electronic device 210 may be expressed, for example, as at least one angle, but an expression form thereof is not limited.

According to various embodiments, the first electronic device 200 may receive a communication signal including information about the orientation of the second electronic device 210 through the first communication module 310a. The processor 330b of the second electronic device 210 may identify the orientation of the second electronic device 210, and may transmit the communication signal including the information about the orientation through the first communication module 310b. The processor 330a of the first electronic device 200 may identify a difference between the orientation of the second electronic device 210 identified based on the received communication signal and the orientation of the first electronic device 200. The second electronic device 210 may receive a communication signal including information about the orientation of the first electronic device 200 through the first communication module 310b. The processor 330a of the first electronic device 200 may identify the orientation of the first electronic device 200, and may transmit the communication signal including the information about the orientation through the first communication module 310a. The processor 330b of the second electronic device 210 may identify a difference between the orientation of the first electronic device 200 identified based on the received communication signal and the orientation of the second electronic device 210.

For example, referring to FIG. 4B, the second electronic device 210 of (a) and (b) of FIG. 4B may be located on one plane. In an x-y coordinate system, the second electronic device 210 of (a) of FIG. 4B may have an orientation such that a first direction of the second electronic device 210 (e.g., a height direction of the second electronic device 210) matches a +y direction. In this case, the second electronic device 210 (e.g., the processor 330b) may identify, based on data from the sensor module 340b, that the orientation of the second electronic device 210 is 0°. In the x-y coordinate system, the second electronic device 210 of (b) of FIG. 4B may have an orientation such that the first direction of the second electronic device 210 (e.g., the height direction of the second electronic device 210) forms an angle (e.g., 30°) with the +y direction. In this case, the second electronic device 210 may identify, based on data from the sensor module 340b, that the orientation of the second electronic device 210 is 30°. Although not shown, in another example, the first electronic device 200 may identify, based on data from the sensor module 340a of the first electronic device 200, that the orientation of the first electronic device 210 is 90°. The second electronic device 210 may identify, based on data from the sensor module 340b of the second electronic device 210, that the orientation of the second electronic device 210 is 180°. The second electronic device 210 may transmit a communication signal including information of 180°, which is the orientation of the second electronic device 210, to the first electronic device 200, based on the first communication method (e.g., BLE communication). The first electronic device 200 may identify that a difference between the orientation of the second electronic device 210 of 180° identified based on the received communication signal and the orientation of the first electronic device 200 is 90°. Although the second electronic device 210 is assumed to be located on one plane in (a) and (b) of FIG. 4B for convenience of explanation, those skilled in the art will understand that the disclosure may also be applied to a 3D space.

Referring to FIG. 3, according to various embodiments, the second communication module 320a and the second communication module 320b may transmit/receive communication signals 313 and 315 (e.g., UWB signals) based on the second communication method. The processor 330a and/or the second communication module 320a may identify the location of the second electronic device 210 (e.g., the distance to the second electronic device 210 and/or the direction of the second electronic device 210), based on a measurement result of a communication signal 315 from the outside. The processor 330b and/or the second communication module 320b may identify the location of the first electronic device 200 (e.g., the distance to the first electronic device 200 and/or the direction of the first electronic device 200), based on a measurement result of a communication signal 313 from the outside.

The power transmission circuit 350a according to various embodiments may wirelessly transmit power 317 according to at least one of an induction method, a resonance method, and an electromagnetic wave method. The power transmission circuit 350a may include a power adapter, a power generation circuit, and a coil. The power adapter may receive power from a power source, and may provide the power to the power generation circuit. The power adapter may be, for example, a power interface, and may not be included in a wireless power transmission device depending on a configuration. The power generation circuit may convert the received power, for example, into an AC waveform, and/or may amplify the received power to transmit the power to the coil. When the power is applied to the coil, an induced magnetic field of which the size changes with time may be formed from the coil, thus wirelessly transmitting the power 317. The processor 330a may determine whether to transmit the power 317, may control a size of the power 317, or may perform at least one function (e.g., starting charging or stopping charging) of the first electronic device 200. The processor 330a or the processor 330b may be configured with various circuits capable of performing an operation, such as a general-purpose processor including a CPU, a minicomputer, a microprocessor, a microcontroller unit (MCU), and a field-programmable gate array (FPGA), and the type thereof is not limited.

The power reception circuit 350b according to various embodiments may wirelessly receive power from the power transmission circuit 350a according to at least one of the induction method, the resonance method, and the electromagnetic wave method. The power reception circuit 350b may perform power processing of rectifying the received power in an AC waveform into a DC waveform, converting a voltage, or regulating the power. A charger of the second electronic device 210 may charge a battery of the second electronic device 210 using the received regulated power (e.g., DC power). The charger may adjust at least one of a voltage or a current of the received power, and may transmit the power to the battery. The battery may store the power, and may transmit the power to other hardware. Although not shown, a power management integrated circuit (PMIC) may receive power from the power reception circuit 350b to transmit the power to other hardware, or may receive power from the battery to transmit the power to other hardware.

According to various embodiments, as illustrated in FIG. 4A, the second communication module 320a of the first electronic device 200 may include a dedicated distance measurement antenna 421 and patch antennas 422, 423, and 424. The second communication module 320b of the second electronic device 210 may include a dedicated distance measurement antenna 441 and patch antennas 442, 443, and 444. The dedicated distance measurement antennas 421 and 441 may be configured, for example, as metal antennas or laser direct structuring (LDS) antennas, but the configuration form thereof is not limited. The dedicated distance measurement antennas 421 and 441 may be configured to be used for a 3GPP-based radio access technology (RAT) (e.g., E-UTRA or NR) in addition to the second communication method (e.g., UWB communication). In this case, the dedicated distance measurement antennas 421 and 441 may be used as shared antennas for the 3GPP-based RAT and UWB communication. The patch antennas 422, 423, 424, 442, 443, and 444 may be configured, for example, as patch antennas, but the configuration form thereof is not limited. For example, parts described as the patch antennas 422, 423, 424, 442, 443, and 444 may be configured as dipole antennas, slot antennas, and/or slit antennas, and the type thereof is not limited. The second communication module 320a may include an RF path for transmitting an RF signal and an RF path for receiving an RF signal in the dedicated distance measurement antenna 421, and thus the dedicated distance measurement antenna 421 may be used for both transmission and reception of a communication signal. The second communication module 320a may include an RF path for transmitting an RF signal and an RF path for receiving an RF signal in the patch antenna 422, and thus the patch antenna 422 may be used for both transmission and reception of a communication signal. The second communication module 320a may include an RF path for receiving an RF signal from the patch antennas 423 and 424, and accordingly the patch antennas 423 and 424 may be used for reception of a communication signal. The second communication module 320b may include an RF path for transmitting an RF signal and an RF path for receiving an RF signal in the dedicated distance measurement antenna 441, and thus the dedicated distance measurement antenna 441 may be used for both transmission and reception of a communication signal. The second communication module 320b may include an RF path for transmitting an RF signal and an RF path for receiving an RF signal in the patch antenna 442, and thus the patch antenna 442 may be used for both transmission and reception of a communication signal. The second communication module 320b may include an RF path for receiving an RF signal from the patch antennas 443 and 444, and accordingly the patch antennas 443 and 444 may be used for reception of a communication signal.

According to various embodiments, the second communication module 320a may transmit a communication signal 461 (e.g., the poll message of FIG. 2A or 2B) using the dedicated distance measurement antenna 421. The second communication module 320b may receive the communication signal 461 using the dedicated distance measurement antenna 441. The second communication module 320b may transmit a communication signal 462 (e.g., the response message of FIG. 2A or 2B) using the dedicated distance measurement antenna 441. The second communication module 320a may receive the communication signal 462 using the dedicated distance measurement antenna 421. The second communication module 320a may transmit a communication signal 463 (e.g., the final message of FIG. 2B) using the dedicated distance measurement antenna 421. The second communication module 320b may receive the communication signal 463 using the dedicated distance measurement antenna 441. The second communication module 320a may identify the distance between the first electronic device 200 and the second electronic device 210, based on a transmission time of the communication signal 461, a reception time of the communication signal 462, and a process time of the second electronic device 210 obtained from the communication signal 462. The second communication module 320b may identify the distance between the first electronic device 200 and the second electronic device 210, based on a transmission time of the communication signal 462, a reception time of the communication signal 463, and a process time of the first electronic device 200 obtained from the communication signal 463. The second communication module 320a may identify the distance between the first electronic device 200 and the second electronic device 210 using the dedicated distance measurement antenna 421.

According to various embodiments, the second communication module 320a may transmit a communication signal 464 using the patch antenna 422. The communication signal 464 may be measured in the patch antennas 442, 443, and 444 of the second communication module 320b. Measurement times of the communication signal 464 and/or measurement phases of the communication signal 464 may be different based on an antenna spacing between the patch antennas 442, 443, and 444. The second communication module 320b may identify the direction of the first electronic device 200 based on the second electronic device 210, based on the measurement times corresponding to the patch antennas 442, 443, and 444 and/or a difference between the measurement phases. The second communication module 320b may transmit a communication signal 465 using the patch antenna 442, and measurement times of the communication signal 465 and/or measurement phases of the communication signal 465 may be different based on an antenna spacing between the patch antennas 442, 443, and 444. The second communication module 320a may identify the direction of the second electronic device 210 based on the first electronic device 200, based on the measurement times corresponding to the patch antennas 422, 423, and 424 and/or a difference between the measurement phases. After the second communication module 320a of the first electronic device 200 transmits the communication signal 464, when the second communication module 320b of the second electronic device 210 transmits the communication signal 465 in response thereto, the second communication module 320a may identify the distance between the first electronic device 200 and the second electronic device 210, based on a transmission time of the communication signal 464, a reception time of the communication signal 465, and a process time of the second electronic device 210 obtained from the communication signal 465. The second communication module 320a may at least simultaneously identify the distance between the first electronic device 200 and the second electronic device 210 and the direction of the second electronic device 210 using the patch antennas 422, 423, and 424. After the second communication module 320b of the second electronic device 210 transmits the communication signal 465, when the second communication module 320a of the first electronic device 200 transmits the communication signal 464 in response thereto, the second communication module 320a may identify the distance between the first electronic device 200 and the second electronic device 210, based on a transmission time of the communication signal 465, a reception time of the communication signal 464, and a process time of the first electronic device 200 obtained from the communication signal 464. The second communication module 320b may at least simultaneously identify the distance between the first electronic device 200 and the second electronic device 210 and the direction of the first electronic device 200 using the patch antennas 442, 443, and 444.

In various embodiments of the disclosure, the first electronic device 200 measuring the location of the second electronic device 210 may refer, for example, to any one of measuring both the distance to the second electronic device 210 and the direction thereof, for example, a plurality of antennas (e.g., the patch antennas 422, 423, and 424) or measuring the distance to the second electronic device 210 using a single antenna (e.g., the dedicated distance measurement antenna 421). Likewise, the second electronic device 210 measuring the location of the first electronic device 200 may refer, for example, to any one of measuring both the distance to the first electronic device 200 and the direction thereof, for example, a plurality of antennas (e.g., the patch antennas 442, 443, and 444) or measuring the distance to the first electronic device 200 using a single antenna (e.g., the dedicated distance measurement antenna 441).

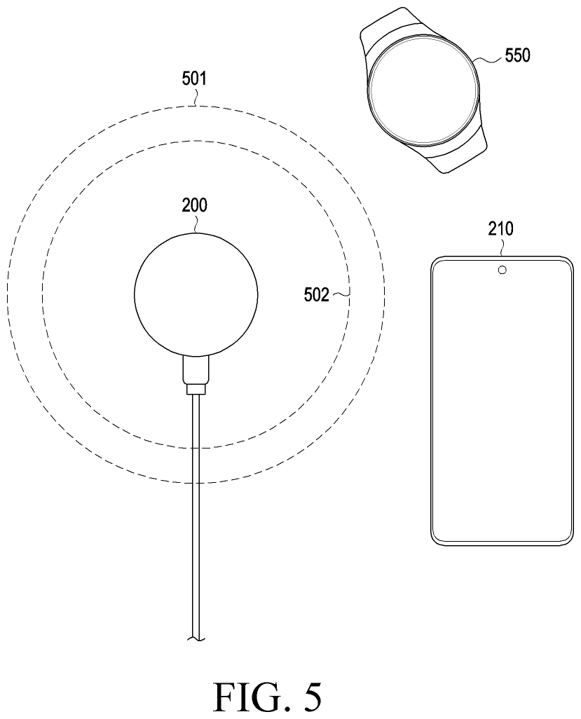

FIG. 5 is a diagram illustrating a charging range of a wireless power transmission device in a wireless power transmission system according to various embodiments.

Referring to FIG. 5, the wireless power transmission system according to various embodiments may include the wireless power transmission device 200, a wireless power reception device 210, and an external device 550. The wireless power transmission device 200 may correspond to the first electronic device 200 of FIG. 3. The wireless power reception device 210 may correspond to the second electronic device 210 of FIG. 3. The external device 550 may be the same type of electronic device as the electronic device 101 of FIG. 1, and the description of the electronic device 101 of FIG. 1 may be applied to the external device 550 within a necessary range.

According to various embodiments, the charging range of the wireless power transmission device 200 may refer to a range in which a different electronic device (e.g., the wireless power reception device 210 and/or the external device 550) is chargeable with wireless power transmitted by the wireless power transmission device 200. The charging range may refer to a range in which a voltage equal to or greater than a specified level is providable to one point (e.g., an output terminal of a rectifier) of the wireless power reception device 210, but is not limited. The charging range may be changed based on at least one of a level of charging power of the wireless power transmission device 200, a charging environment, a type of a wireless power reception device, or the number of wireless power reception devices charged by one wireless power transmission device 200. For example, when the different electronic device is charged only when a distance between the different electronic device and the wireless power transmission device 200 is within a first distance (e.g., the voltage equal to or greater than the specified level is applied to an output terminal of a rectifier of the different electronic device), the charging range may refer to a range of the first distance from the wireless power transmission device 200. The charging range may be configured based on the level of the charging power of the wireless power transmission device 200 and a size of each wireless power reception coil of the different electronic device to be charged. Alternatively, the charging range may refer to a range in which the different electronic device is chargeable with a certain efficiency or higher. For example, even though the different electronic device is charged when the different electronic device is located at a second distance from the wireless power transmission device 200, when charging efficiency of the different electronic device is a certain level or higher only when the different electronic device is located within a third distance from the wireless power transmission device 200 shorter than the second distance, the charging range may refer to a range of the third distance from the wireless power transmission device 200. When a criterion for the charging range is charging efficiency, the charging efficiency may be configured differently or the same according to a device to be charged, and the charging range may be configured differently according to a type of the different electronic device to be charged or be configured the same regardless of the type of the different electronic device to be charged. When the number of different electronic devices to be charged is changed, the charging range of the wireless power transmission device 200 may be changed.

According to various embodiments, the wireless power transmission device 200 may receive a signal related to charging of the different electronic device (e.g., the wireless power reception device 210 and/or the external device 550) from the different electronic device through the first communication module 310a. For example, the signal related to the charging of the different electronic device may include information about an ID of the different electronic device and/or information related to initiation of wireless charging of the different electronic device. The information related to the initiation of wireless charging of the different electronic device may include information indicating that the different electronic device is in a state of being wirelessly chargeable and/or information about the level of the voltage applied to the output terminal of the rectifier of the different electronic device, but is not limited. The wireless power transmission device 200 may determine a charging range corresponding to the different electronic device, based on the signal related to the charging of the different electronic device received from the different electronic device.

According to various embodiments, referring to FIG. 5, the charging range of the wireless power transmission device 200 may include a first charging range 501 and/or a second charging range 502. For example, the first charging range 501 may be a charging range corresponding to the wireless power reception device 210. The wireless power reception device 210 may be wirelessly charged or is capable of wireless charging with the certain efficiency or higher when being located within the first charging range 501, which is the first distance from the wireless power transmission device 200. The second charging range 502 may be a charging range corresponding to the external device 550. The external device 550 may be wirelessly charged or is capable of wireless charging with the certain efficiency or higher when being located within the second charging range 502, which is the second distance from the wireless power transmission device 200. For example, referring to FIG. 5, the second charging range 502 may refer to a range in which the distance from the wireless power transmission device 200 is shorter than that in the first charging range 501. FIG. 5 shows that the first charging range 501 and the second charging range 502 are different, which is for illustration, and the first charging range 501 and the second charging range 502 are configured to be the same.

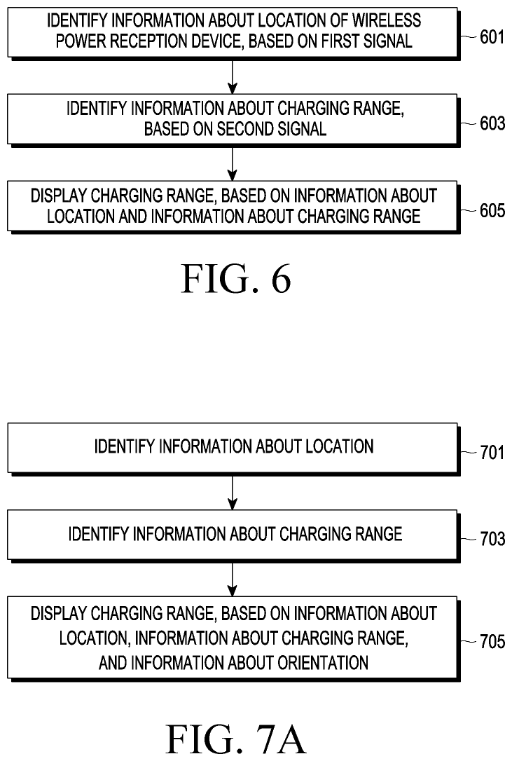

FIG. 6 is a flowchart illustrating an example method of operating a wireless power reception device according to various embodiments.

Referring to FIG. 6, according to various embodiments, in operation 601, the wireless power reception device 210 (e.g., a processor 330b) may identify information about a location of the wireless power reception device 210 based on a wireless power transmission device 200, based on a first signal received from the wireless power transmission device 200. For example, the wireless power transmission device 200 (e.g., a processor 330a) may measure the location (e.g., direction and distance) of the wireless power reception device 210, based on a communication signal between the second communication module 320a and the second communication module 320b. The location of the wireless power reception device 210 measured by the wireless power transmission device 200 may refer to a distance from the wireless power transmission device 200 to the wireless power reception device 210 and a direction in which the wireless power reception device 210 is located based on the wireless power transmission device 200. The wireless power reception device 210 may receive a first signal including the information about the location of the wireless power reception device 210 measured by the wireless power transmission device 200 from the wireless power transmission device 200 using a first communication module 310b.

According to various embodiments, in operation 603, the wireless power reception device 210 may identify information about a charging range of the wireless power transmission device 200, based on a second signal received from the wireless power transmission device 200. For example, the wireless power transmission device 200 may determine a charging range corresponding to the wireless power reception device 210 in relation to charging of the wireless power reception device 210. The wireless power reception device 210 may receive the second signal including information about the charging range (e.g., the charging range corresponding to the wireless power reception device 210) determined by the wireless power transmission device 200 from the wireless power transmission device 200 through the first communication module 310b, and may identify the information about the charging range of the wireless power transmission device 200, based on the received second signal. Although FIG. 6 shows that the information about the location of the wireless power reception device 210 and the information about the charging range thereof are identified based on the first signal and the second signal, respectively, which is for illustration, the wireless power reception device 210 may be configured to identify the information about the location of the wireless power reception device 210 and the information about the charging range thereof included in one signal (or packet) from the wireless power transmission device 200.

According to various embodiments, in operation 605, the wireless power reception device 210 may display the charging range of the wireless power transmission device 200 on a display (e.g., the display module 160 of FIG. 1) of the wireless power reception device 210, based on the information about the location of the wireless power reception device 210 identified based on the first signal and the information about the charging range of the wireless power transmission device 200 identified based on the second signal. For example, the wireless power reception device 210 may identify a relative location between the charging range of the wireless power transmission device 200 and the wireless power reception device 210, based on the information about the location of the wireless power reception device 210 based on the wireless power transmission device 200 and the information about the charging range of the wireless power transmission device 200, and may determine a location or form in which the charging range of the wireless power transmission device 200 is displayed.

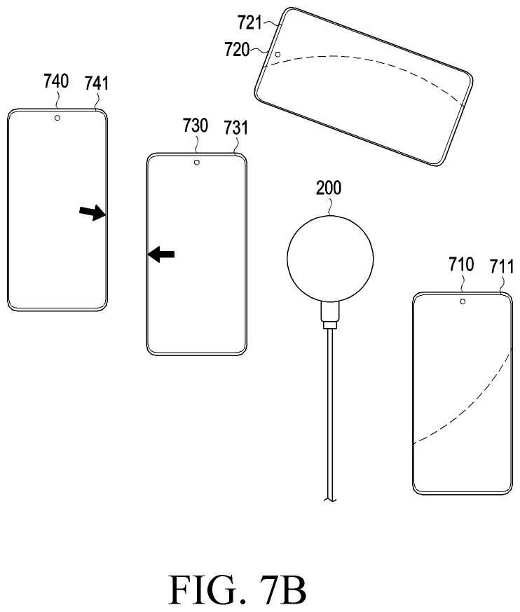

FIG. 7A is a flowchart illustrating an example method of operating a wireless power reception device according to various embodiments. FIG. 7A will be described with reference to FIG. 7B. FIG. 7B is a diagram illustrating a display of a display of a wireless power reception device according to various embodiments.

Referring to FIG. 7A, according to various embodiments, in operation 701, the wireless power reception device 210 (e.g., a processor 330b) may receive a first signal including information about a location of the wireless power reception device 210 measured by a wireless power transmission device 200 from the wireless power transmission device 200 using a first communication module 310b, and may identify the information about the location of the wireless power reception device 210, based on the received first signal. The wireless power reception device 210 may receive a signal including information about an orientation of the wireless power transmission device 200 from the wireless power transmission device 200 using the first communication module 310b, and may identify the information about the orientation of the wireless power transmission device 200, based on the received signal. The information about the location of the wireless power reception device 210 and the information about the orientation of the wireless power transmission device 200 may be included in the same signal or in separate signals, without being limited thereto.

According to various embodiments, in operation 703, the wireless power reception device 210 may receive a second signal including information about a charging range (e.g., a charging range corresponding to the wireless power reception device 210) determined by the wireless power transmission device 200 from the wireless power transmission device 200 through the first communication module 310b, and may identify information about a charging range of the wireless power transmission device 200, based on the received second signal.

According to various embodiments, in operation 705, the wireless power reception device 210 may display the charging range of the wireless power transmission device 200 on the display (e.g., the display module 160 of FIG. 1) of the wireless power reception device 210, based on the information about the location of the wireless power reception device 210 identified based on the first signal, the information about the charging range of the wireless power transmission device 200 identified based on the second signal, and the information about the orientation. For example, the wireless power reception device 210 may identify a relative location between the charging range of the wireless power transmission device 200 and the wireless power reception device 210, based on the information about the location of the wireless power reception device 210 based on the wireless power transmission device 200, the information about the charging range of the wireless power transmission device 200, and the information about the orientation, and may determine a location or form in which the charging range of the wireless power transmission device 200 is displayed.

For example, the wireless power reception device 210 may identify an orientation difference between the wireless power transmission device 200 and the wireless power reception device 210, based on the information about the orientation of the wireless power transmission device 200 identified based on the signal received from the wireless power transmission device 200 and data from a sensor module 340b. The wireless power reception device 210 may identify information about a location (e.g., direction and distance) of the wireless power transmission device 200, based on the identified orientation difference and the information about the location of the wireless power reception device 200 measured by the wireless power transmission device 200. For example, when the orientation of the wireless power transmission device 200 is 60° and an orientation of the wireless power reception device 210 is 30°, the wireless power reception device 210 may identify an orientation difference of 30° (=60°−30°) between the wireless power transmission device 200 and the wireless power reception device 210. Further, when a direction of the wireless power reception device 210 based on the wireless power transmission device 200 is 45°, the wireless power reception device 210 may identify the direction (105°=180°−45°−30°) of the wireless power transmission device 200 based on the wireless power reception device 210, based on the orientation difference (30°) between the wireless power transmission device 200 and the wireless power reception device 210 and the direction (45°) of the wireless power reception device 210 based on the wireless power transmission device 200. The wireless power reception device 210 may display the charging range of the wireless power transmission device 200 on the display (e.g., the display module 160 of FIG. 1), based on a distance between the wireless power transmission device 200 and the wireless power reception device 210 and the direction (e.g., 105°) of the wireless power transmission device 200 based on the wireless power reception device 210.

According to various embodiments, referring to FIG. 7B, a wireless power transmission system may include a wireless power transmission device 200, a first wireless power reception device 710, a second wireless power reception device 720, a third wireless power reception device 730, and a fourth wireless power reception device 740. The first wireless power reception device 710, the second wireless power reception device 720, the third wireless power reception device 730, and/or the fourth wireless power reception device 740 may correspond to the wireless power reception device 210 of FIG. 3.

According to various embodiments, referring to FIG. 7B, the first wireless power reception device 710 may display a charging range of the wireless power transmission device 200 on at least a portion of a display 711 of the first wireless power reception device 710, based on at least the portion of the display 711 of the first wireless power reception device 710 corresponding to the charging range of the wireless power transmission device 200. The second wireless power reception device 720 may display the charging range of the wireless power transmission device 200 on at least a portion of a display 721 of the second wireless power reception device 720, based on at least the portion of the display 721 of the second wireless power reception device 720 corresponding to the charging range of the wireless power transmission device 200.

For example, referring to FIG. 7B, the first wireless power reception device 710 and the second wireless power reception device 720 may be located at the same distance (e.g., 20 cm) from the wireless power transmission device 200. Here, a direction of the first wireless power reception device 710 based on the wireless power transmission device 200 may be 135°, and a direction of the second wireless power reception device 720 based on the wireless power transmission device 200 may be 15°. An orientation of the wireless power transmission device 200 may be 0°, an orientation of the first wireless power reception device 710 may be 0°, and an orientation of the second wireless power reception device 720 may be −70°. An orientation difference between the wireless power transmission device 200 and the first wireless power reception device 710 may be 0° (=0°−0°), and an orientation difference between the wireless power transmission device 200 and the second wireless power reception device 710 may be 70° (=0°−(−70°)). A direction of the wireless power transmission device 200 based on the first wireless power reception device 710 may be 45° (=180°−135°−0°), and a direction of the wireless power transmission device 200 based on the second wireless power reception device 720 may be 95° (=180°−15°−70°). Accordingly, the first wireless power reception device 710 may identify a location of the wireless power transmission device 200, for example, as 20 cm and 45°. The second wireless power reception device 720 may identify the location of the wireless power transmission device 200, for example, as 20 cm and 95°. Therefore, referring to FIG. 7B, even though the first wireless power reception device 710 and the second wireless power reception device 720 are located at the same distance (e.g., 20 cm) from the wireless power transmission device 200, when the direction (e.g., 45°) of the wireless power transmission device 200 identified by the first wireless power reception device 710 and the direction (e.g., 95°) of the wireless power transmission device 200 identified by the second wireless power reception device 720 are different, a direction in which the charging range of the wireless power transmission device 200 is displayed on the display 711 of the first wireless power reception device 710 and a direction in which the charging range of the wireless power transmission device 200 is displayed on the display 721 of the second wireless power reception device 720 may be different.

According to various embodiments, the wireless power reception device 210 (e.g., the third wireless power reception device 730 or the fourth wireless power reception device 740 of FIG. 7B) may display at least one object and/or a graphic effect corresponding to a direction of the charging range of the wireless power transmission device 200 on the display (e.g., the display module 160 of FIG. 1) of the wireless power reception device 210 (e.g., a display 731 of the third wireless power reception device 730 or a display 741 of the fourth wireless power reception device 740 of FIG. 7B), based on the location of the wireless power reception device 210 being outside a specified range corresponding to the charging range of the wireless power transmission device 200.

Referring to FIG. 7B, for example, the third wireless power reception device 730 may be located outside the specified range corresponding to the charging range of the wireless power transmission device 200, for example, inside the charging range of the wireless power transmission device 200. The third wireless power reception device 730 may display at least one object corresponding to the direction of the charging range of the wireless power transmission device 200 (e.g., an arrow object indicating the direction of the charging range of the wireless power transmission device 200) on the display 731 of the third wireless power reception device 730, based on the third wireless power reception device 730 being located outside the specified range corresponding to the charging range of the wireless power transmission device 200. For example, the fourth wireless power reception device 740 may be located outside the specified range corresponding to the charging range of the wireless power transmission device 200, for example, outside the charging range of the wireless power transmission device 200. The fourth wireless power reception device 740 may display at least one object corresponding to the direction of the charging range of the wireless power transmission device 200 (e.g., an arrow object indicating the direction of the charging range of the wireless power transmission device 200) on the display 741 of the fourth wireless power reception device 740, based on the fourth wireless power reception device 740 being located outside the specified range corresponding to the charging range of the wireless power transmission device 200. Although not shown, the wireless power reception device 210 may display a graphic effect (e.g., a gradation effect corresponding to the direction of the charging range of the power transmission device 200) together with the arrow object or separately from the arrow object on the display (e.g., the display module 160 of FIG. 1).

According to various embodiments, referring to FIG. 7B, a direction in which the at least one object corresponding to the direction of the charging range of the wireless power transmission device 200 (e.g., the arrow object indicating the direction of the charging range of the wireless power transmission device 200) displayed on the display 731 of the third wireless power reception device 730 (or the display 741 of the fourth wireless power reception device 740) is displayed may be determined according to a location and orientation of the wireless power transmission device 200 and a location and orientation of the third wireless power reception device 730 (or the fourth wireless power reception device 740). Those skilled in the art will understand that a method for determining the direction of the at least one object (e.g., the arrow object) displayed on the display according to the location and the orientation may be similar to the foregoing method for determining the direction of the charging range displayed on the display according to the location and the orientation.

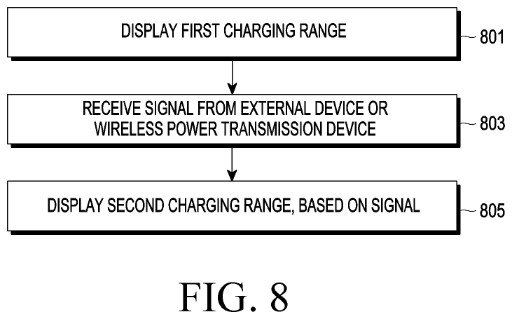

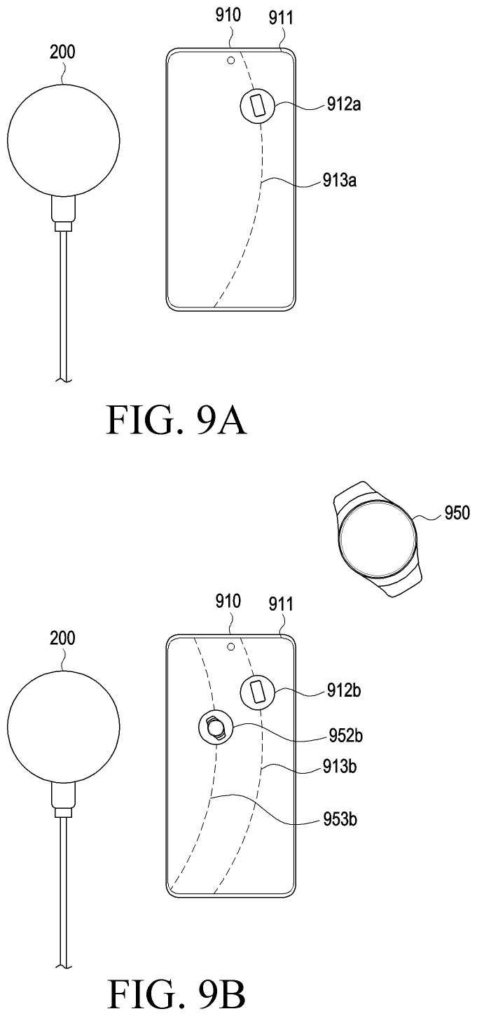

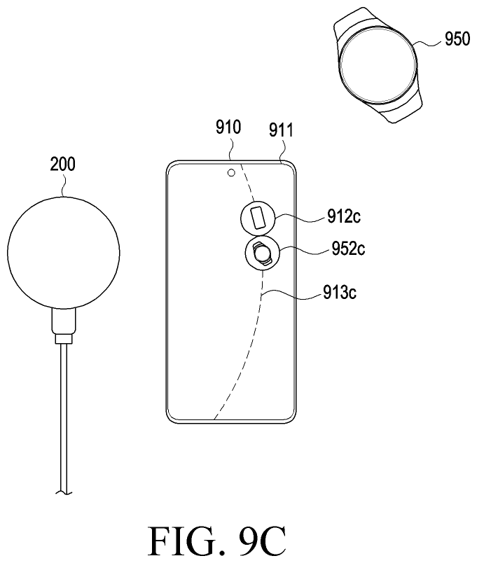

FIG. 8 is a flowchart illustrating an example method of operating a wireless power reception device according to various embodiments. FIG. 8 will be described with reference to FIG. 9A, FIG. 9B, and FIG. 9C. FIG. 9A is a diagram illustrating a display of a display of a wireless power reception device according to various embodiments. FIG. 9B is a diagram illustrating a display of a display of a wireless power reception device according to various embodiments. FIG. 9C is a diagram illustrating a display of a display of a wireless power reception device according to various embodiments. The wireless power reception device 910 illustrated in FIG. 9A, FIG. 9B, and FIG. 9C may correspond to the wireless power reception device 210 of FIG. 3. The wireless power reception device 910 may include a display 911 (e.g., the display module 160 of FIG. 1). An external device 950 illustrated in FIG. 9A, FIG. 9B, and FIG. 9C may correspond to the external device 550 of FIG. 5.

Referring to FIG. 8, according to various embodiments, in operation 801, the wireless power reception device 910 (e.g., a processor 330b of FIG. 3) may display a first charging range of a wireless power transmission device 200 on the display 911. For example, the wireless power reception device 910 may receive a signal including information about the first charging range (e.g., a charging range corresponding to the power reception device 910) of the wireless power transmission device 200 from the wireless power transmission device 200 through a first communication module 310b, and may identify the information about the first charging range of the wireless power transmission device 200, based on the received signal. Referring to FIG. 9A, the wireless power reception device 910 may display a first charging range 913a on a display 911, based on the identified information about the first charging range. A method for displaying the charging range of the wireless power transmission device 200 based on information about a location of the wireless power reception device 910, the information about the charging range of the wireless power transmission device 200, and information about an orientation has been described above. For example, referring to FIG. 9A, while displaying the first charging range 913a on the display 911, the wireless power reception device 910 may display a first object 912a corresponding to the first charging range 913a and the wireless power reception device 910 on the display 911. The first object 912a may indicate that the first charging range 913a displayed on the display 911 is the charging range corresponding to the wireless power reception device 910.

According to various embodiments, in operation 803, the wireless power reception device 910 may receive a signal including information related to charging of the external device (e.g., the external device 950 of FIG. 9B) from the external device 950 or the wireless power transmission device 200 through the first communication module 310b. For example, the information related to the charging of the external device 950 may include at least one of ID information about the external device 950, information about whether the external device 950 is being charged by the wireless power transmission device 200, information about charging power transmitted from the wireless power transmission device 200 to the external device 950, or information about a second charging range of the wireless power transmission device 200 (e.g., a charging range of the wireless power transmission device 200 corresponding to the external device 950). For example, the external device 950 may transmit the signal including the information related to the charging of the external device 950 to the wireless power reception device 910. Alternatively, in another example, the wireless power transmission device 200 may transmit the signal including the information related to the charging of the external device 950 to the wireless power reception device 910.

According to various embodiments, in operation 805, the wireless power reception device 910 may identify the second charging range of the wireless power transmission device 200 (e.g., the charging range of the wireless power transmission device 200 corresponding to the external device 950), based on the signal received from the external device 950 or the wireless power transmission device 200, and may display the identified second charging range on the display 911. For example, referring to FIG. 9B, when a first charging range (e.g., the charging range of the wireless power transmission device 200 corresponding to the wireless power reception device 910) and a second charging range (e.g., the charging range of the wireless power transmission device 200 corresponding to the external device 950) are different, the wireless power reception device 910 may display the first charging range 913b corresponding to the wireless power reception device 910, a first object 912b corresponding to the first charging range 913b and corresponding to the wireless power reception device 910, a second charging range 953b corresponding to the external device 950, and a second object 952b corresponding to the second charging range 953b and corresponding to the external device 950 on the display 911. Alternatively, in another example, referring to FIG. 9C, when a first charging range (e.g., the charging range of the wireless power transmission device 200 corresponding to the wireless power reception device 910) and a second charging range (e.g., the charging range of the wireless power transmission device 200 corresponding to the external device 950) are the same, the wireless power reception device 910 may display a charging range 913c corresponding to the wireless power reception device 910 and the external device 950, a first object 912c corresponding to the charging range 913c and corresponding to the wireless power reception device 910, and a second object 952c corresponding to the charging range 913c and corresponding to the external device 950 on the display 911.

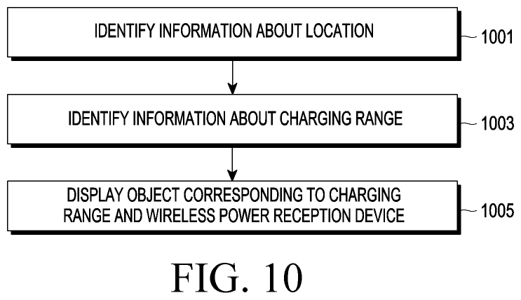

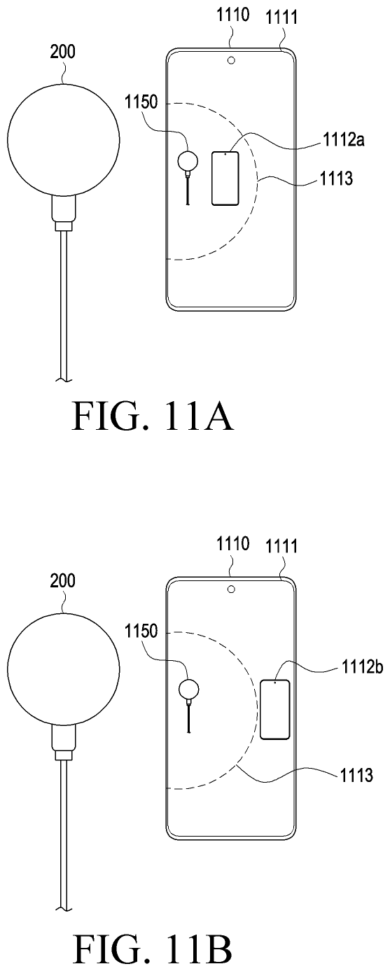

FIG. 10 is a flowchart illustrating an example method of operating a wireless power reception device according to various embodiments. FIG. 10 will be described with reference to FIG. 11A and FIG. 11B. FIG. 11A is a diagram illustrating a display of a display of a wireless power reception device according to various embodiments. FIG. 11B is a diagram illustrating a display of a display of a wireless power reception device according to various embodiments. The wireless power reception device 1110 illustrated in FIG. 11A and FIG. 11B may correspond to the wireless power reception device 210 of FIG. 3. The wireless power reception device 1110 may include a display 1111 (e.g., the display module 160 of FIG. 1).

Referring to FIG. 10, according to various embodiments, in operation 1001, the wireless power reception device 1110 (e.g., a processor 330b) may receive a first signal including information about a location of the wireless power reception device 1110 measured by a wireless power transmission device 200 from the wireless power transmission device 200 using a first communication module 310b, and may identify the information about the location of the wireless power reception device 1110, based on the received first signal.

According to various embodiments, in operation 1003, the wireless power reception device 1110 may receive a second signal including information about a charging range (e.g., a charging range corresponding to the wireless power reception device 1110) determined by the wireless power transmission device 200 from the wireless power transmission device 200 through the first communication module 310b, and may identify information about a charging range of the wireless power transmission device 200, based on the received second signal.

According to various embodiments, in operation 1005, the wireless power reception device 1110 may display an object corresponding to the charging range of the wireless power transmission device 200 and an object corresponding to the wireless power reception device 1110 on the display 1111 of the wireless power reception device 210, based on the information about the location of the wireless power reception device 210 identified based on the first signal and the information about the charging range of the wireless power transmission device 200 identified based on the second signal. For example, the wireless power reception device 210 may display the object corresponding to the charging range of the wireless power transmission device 200 and the object corresponding to the wireless power reception device 1110 by identifying a relative location between the charging range of the wireless power transmission device 200 and the wireless power reception device 210, based on the information about the location of the wireless power reception device 210 based on the wireless power transmission device 200 and the information about the charging range of the wireless power transmission device 200. The object corresponding to the wireless power reception device 1110 may refer to an icon for displaying the location of the wireless power reception device 1110.

For example, referring to FIG. 11A, when a distance between the wireless power reception device 1110 and the wireless power transmission device 200 is shorter than an actual distance corresponding to the charging range of the wireless power transmission device 200, the wireless power reception device 1110 may display an object 1112a corresponding to the wireless power reception device 1110 inside an object 1113 corresponding to the charging range of the wireless power transmission device 200 displayed on the display 1111. In another example, referring to FIG. 11B, when the distance between the wireless power reception device 1110 and the wireless power transmission device 200 is longer than the actual distance corresponding to the charging range of the wireless power transmission device 200, the wireless power reception device 1110 may display an object 1112b corresponding to the wireless power reception device 1110 outside an object 1113 corresponding to the charging range of the wireless power transmission device 200 displayed on the display 1111. For example, referring to FIG. 11A and FIG. 11B, the wireless power reception device 1110 may display an object 1150 corresponding to the wireless power transmission device 200 on the display 1111.

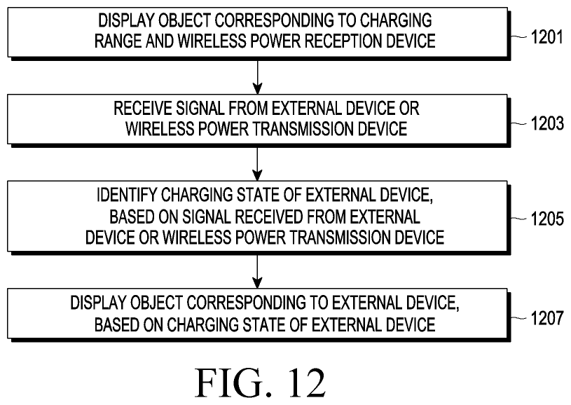

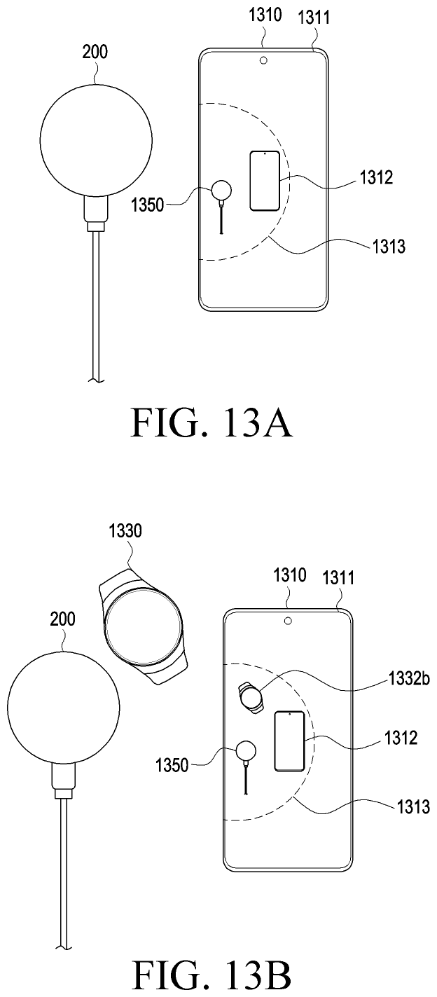

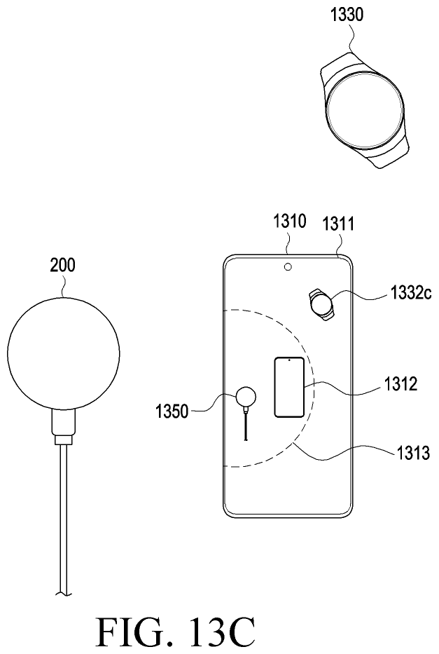

FIG. 12 is a flowchart illustrating an example method of operating a wireless power reception device according to various embodiments. FIG. 12 will be described with reference to FIG. 13A, FIG. 13B, and FIG. 13C. FIG. 13A is a diagram illustrating a display of a display of a wireless power reception device according to various embodiments. FIG. 13B is a diagram illustrating a display of a display of a wireless power reception device according to various embodiments. FIG. 13C is a diagram illustrating a display of a display of a wireless power reception device according to various embodiments. The wireless power reception device 1310 illustrated in FIG. 13A, FIG. 13B, and FIG. 13C may correspond to the wireless power reception device 210 of FIG. 3. The wireless power reception device 1310 may include a display 1311 (e.g., the display module 160 of FIG. 1). An external device 1330 illustrated in FIG. 13B and FIG. 13C may correspond to the external device 550 of FIG. 5.

Referring to FIG. 12, according to various embodiments, in operation 1201, the wireless power reception device 1310 (e.g., a processor 330b) may display an object corresponding to a charging range of the wireless power transmission device 200 and an object corresponding to the wireless power reception device 1110 on the display 1311 of the wireless power reception device 1310, based on information about a location of the wireless power reception device 1310 identified based on a first signal and information about the charging range of the wireless power transmission device 200 identified based on a second signal. For example, referring to FIG. 13A, FIG. 13B, and FIG. 13C, when a distance between the wireless power reception device 1310 and the wireless power transmission device 200 is shorter than an actual distance corresponding to the charging range of the wireless power transmission device 200, the wireless power reception device 1310 may display an object 1312 corresponding to the wireless power reception device 1310 inside an object 1313 corresponding to the charging range of the wireless power transmission device 200 displayed on the display 1311. For example, referring to FIG. 13A, FIG. 13B, and FIG. 13C, the wireless power reception device 1310 may display an object 1350 corresponding to the wireless power transmission device 200 on the display 1311.

According to various embodiments, in operation 1203, the wireless power reception device 1310 may receive a signal including information related to charging of an external device (e.g., the external device 1330 of FIG. 13B or FIG. 13C) from the external device 1330 or the wireless power transmission device 200 through a first communication module 310b. For example, the information related to the charging of the external device 1330 may include at least one of ID information about the external device 1330, information about whether the external device 1330 is being charged, information about charging power received by the external device 1330, or information about a charging range of the wireless power transmission device 200 corresponding to the external device 1330.

According to various embodiments, in operation 1205, the wireless power reception device 1310 may identify a charging state of the external device 1330, based on the information related to the charging of the external device 1330 included in the signal received from the external device 1330 or the wireless power transmission device 200. The wireless power reception device 1310 identifying the charging state of the external device 1330 may refer, for example, to identifying that the external device 1330 is being charged or identifying that the external device 1330 is not being charged. For example, the wireless power reception device 1310 may identify that the external device 1330 is being charged, based on information indicating that that the external device 1330 is being charged. Alternatively, the wireless power reception device 1310 may identify that the external device 1330 is being charged, based on identifying that the charging power received by the external device 1330 is a first threshold value or greater. Alternatively, the wireless power reception device 1310 may identify that the external device 1330 is being charged, based on identifying that a voltage applied to an output terminal of a rectifier of the external device 1330 has a level of a second threshold value or greater. The wireless power reception device 1310 identifying that the external device 1330 is being charged may refer, for example, to identifying that the external device 1330 is located inside the charging range of the wireless power transmission device 200. In another example, the wireless power reception device 1310 may identify that the external device 1330 is not being charged, based on information indicating that the external device 1330 is not being charged. Alternatively, the wireless power reception device 1310 may identify that the external device 1330 is not being charged, based on identifying that the charging power received by the external device 1330 is less than the first threshold value. Alternatively, the wireless power reception device 1310 may identify that the external device 1330 is not being charged, based on identifying that the voltage applied to the output terminal of the rectifier of the external device 1330 has a level less than the second threshold value. The wireless power reception device 1310 identifying that the external device 1330 is not being charged may refer, for example, to identifying that the external device 1330 is located outside the charging range of the wireless power transmission device 200.

According to various embodiments, in operation 1207, the wireless power reception device 1310 may display an object corresponding to the external device 1330 on the display 1311 of the wireless power reception device 1310, based on the charging state of the external device 1330. For example, referring to FIG. 13B, the wireless power reception device 1310 may display an object 1332b corresponding to the external device 1330 inside the object 1313 corresponding to the charging range of the wireless power transmission device 200 displayed on the display 1311, based on identifying that the external device 1330 is being charged. In another example, referring to FIG. 13C, the wireless power reception device 1310 may display an object 1332c corresponding to the external device 1330 outside the object 1313 corresponding to the charging range of the wireless power transmission device 200 displayed on the display 1311, based on identifying that the external device 1330 is not being charged.

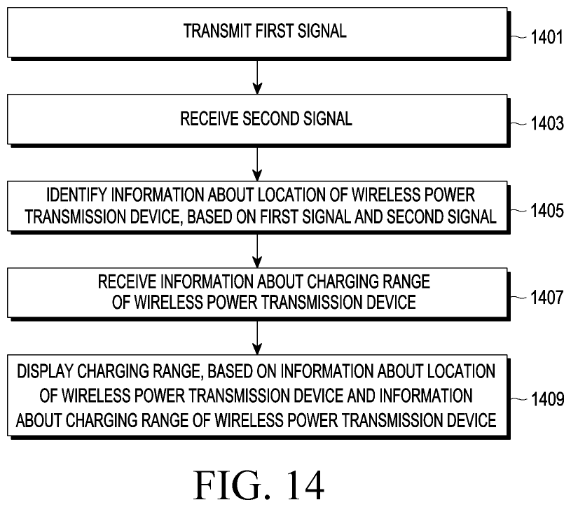

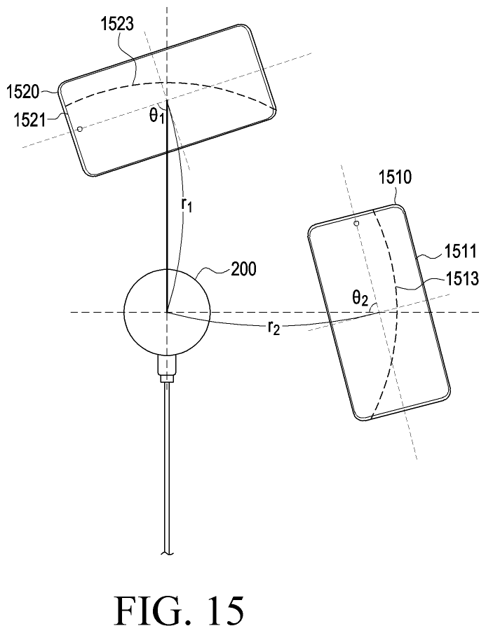

FIG. 14 is a flowchart illustrating an example method of operating a wireless power reception device according to various embodiments. FIG. 14 will be described with reference to FIG. 15. FIG. 15 is a diagram illustrating a display of a display of a wireless power reception device according to various embodiments. The first wireless power reception device 1510 and/or the second wireless power reception device 1520 illustrated in FIG. 15 may correspond to the wireless power reception device 210 of FIG. 3. The first wireless power reception device 1510 may include a display 1511 (e.g., the display module 160 of FIG. 1). The second wireless power reception device 1520 may include a display 1521 (e.g., the display module 160 of FIG. 1).

Referring to FIG. 14, according to various embodiments, in operation 1401, the wireless power reception device (e.g., the wireless power reception device 210 of FIG. 3) (e.g., a processor 330b of FIG. 3) may transmit a first signal (e.g., the poll message of FIG. 2A or FIG. 2B) through a second communication module 320b. A wireless power transmission device 200 may receive the first signal through a second communication module 320a. The wireless power transmission device 200 may transmit a second signal (e.g., the response message of FIG. 2A or FIG. 2B) through the second communication module 320a.

According to various embodiments, in operation 1403, the wireless power reception device 210 may receive the second signal (e.g., the response message of FIG. 2A or FIG. 2B) through the second communication module 320b.

According to various embodiments, in operation 1405, the wireless power reception device 210 may identify information about a location (e.g., direction and distance) of the wireless power transmission device 200, based on the first signal and the second signal. For example, the wireless power reception device 210 may identify a distance between the wireless power transmission device 200 and the wireless power reception device 210, based on a transmission time of the first signal (e.g., the poll message of FIG. 2A or FIG. 2B), a reception time of the second signal (e.g., the response message of FIG. 2A or FIG. 2B), and a process time of the wireless power transmission device 200 obtained from the second signal. The wireless power reception device 210 may identify a direction of the wireless power transmission device 200 based on the wireless power reception device 210, based on a difference between measurement times and/or measurement phases corresponding to a plurality of patch antennas of the second communication module 320b.

According to various embodiments, in operation 1407, the wireless power reception device 210 may receive a signal including information about a charging range (e.g., a charging range corresponding to the wireless power reception device 210) of the wireless power transmission device 200 from the wireless power transmission device 200 through the first communication module 310b, and may identify the information about the charging range of the wireless power transmission device 200, based on the received signal.

According to various embodiments, in operation 1409, the wireless power reception device 210 may display the charging range of the wireless power transmission device 200 on a display (e.g., the display module 160 of FIG. 1) of the wireless power reception device 210, based on information about the location of the wireless power transmission device 200 based on the wireless power reception device 210 and the information about the charging range of the wireless power transmission device 200.

For example, referring to FIG. 15, the first wireless power reception device 1510 may display a charging range of the wireless power transmission device 200 on the display 1511, based on information about a location (e.g., distance r2 and direction θ2) of the wireless power transmission device 200 based on the first wireless power reception device 1510 and information about the charging range of the wireless power transmission device 200. The second wireless power reception device 1520 may display a charging range of the wireless power transmission device 200 on the display 1521, based on information about a location (e.g., distance r1 and direction θ1) of the wireless power transmission device 200 based on the second wireless power reception device 1520 and information about the charging range of the wireless power transmission device 200. Referring to FIG. 15, the location of the first wireless power reception device 1510 and the location of the second wireless power reception device 1520 may be different from each other. Here, the information about the location (e.g., distance r2 and direction θ2) of the wireless power transmission device 200 based on the first wireless power reception device 1510 and the information about the location (e.g., distance r1 and direction θ1) of the wireless power transmission device 200 based on the second wireless power reception device 1520 may be the same. For example, r1=r2 and θ1=θ2. In this case, the charging range 1513 of the wireless power transmission device 200 displayed on the display 1511 of the first wireless power reception device 1510 and the charging range 1523 of the wireless power transmission device 200 displayed on the display 1521 of the second wireless power reception device 1520 may have the same shape. Although not shown, when the information about the location (e.g., distance r2 and direction θ2) of the wireless power transmission device 200 based on the first wireless power reception device 1510 and the information about the location (e.g., distance r1 and direction θ1) of the wireless power transmission device 200 based on the second wireless power reception device 1520 are different, the charging range 1513 of the wireless power transmission device 200 displayed on the display 1511 of the first wireless power reception device 1510 and the charging range 1523 of the wireless power transmission device 200 displayed on the display 1521 of the second wireless power reception device 1520 may have different shapes.

According to various example embodiments, a method of operating a wireless power reception device may include: identifying information about a location of the wireless power reception device based on a wireless power transmission device, based on a first signal received from the wireless power transmission device using at least one communication module comprising communication circuitry (e.g., the first communication module 310b and/or the second communication module 320b) of the wireless power reception device, identifying information about a first charging range of the wireless power transmission device, based on a second signal received from the wireless power transmission device y using the at least one communication module, and displaying the location of the wireless power reception device in a first icon and displaying the first charging range in a line or a face on a display (e.g., the display module 160) of the wireless power reception device, based on the information about the location of the wireless power reception device and the information about the first charging range of the wireless power transmission device.

According to various example embodiments, the method may further include: identifying information about an orientation of the wireless power reception device using at least one sensor (e.g., the sensor module 340b) of the wireless power reception device, and the displaying of the first charging range may include: identifying a relative location between the charging range of the wireless power transmission device and the wireless power reception device, based on the information about the location of the wireless power reception device, the information about the first charging range of the wireless power transmission device, and the information about the orientation of the wireless power reception device, determining a location and a form in which the first charging range is displayed on the display, based on the identified relative location, and displaying the first charging range on the display of the wireless power reception device, based on the determining.

According to various example embodiments, the displaying of the first charging range on the display may include displaying the first charging range in at least a portion of the display, based on at least the portion corresponding to the first charging range.

According to various example embodiments, the method may further include displaying at least one object and/or a graphic effect corresponding to a direction of the first charging range on the display, based on the location of the wireless power reception device being outside a specified range corresponding to the first charging range.

According to various example embodiments, the displaying of the first charging range on the display may include displaying a first object corresponding to the first charging range and corresponding to the wireless power reception device on the display.

According to various example embodiments, the method may further include: receiving a third signal from the wireless power transmission device or an external device using the at least one communication module, and displaying a second charging range on the display, based on the third signal.

According to various example embodiments, the displaying of the second charging range may include displaying a second object corresponding to the second charging range and corresponding to the external device on the display.

According to various example embodiments, the method may further include: identifying a relative location between the first charging range of the wireless power transmission device and the wireless power reception device, based on a result of comparing the location of the wireless power reception device based on the wireless power transmission device and the first charging range, and determining a location in which the first icon indicating the location of the wireless power reception device is displayed on the display, based on the identified relative location.

According to various example embodiments, the method may further include: receiving a third signal from the wireless power transmission device or an external device using the at least one communication module, identifying a charging state of the external device, based on the third signal, and displaying a second icon corresponding to a location of the external device on the display, based on the charging state of the external device.

According to various example embodiments, at least part of the at least one communication module may support ultra-wideband.

According to various example embodiments, a wireless power reception device may include: a display (e.g., the display module 160), at least one communication module comprising communication circuitry (e.g., the first communication module 310b and/or the second communication module 320b), and a processor, wherein the processor may be configured to: identify information about a location of the wireless power reception device based on a wireless power transmission device, based on a first signal received from the wireless power transmission device using the at least one communication module, identify information about a first charging range of the wireless power transmission device, based on a second signal received from the wireless power transmission device using the at least one communication module, and control the display to display the location of the wireless power reception device in a first icon and to display the first charging range in a line or a face, based on the information about the location of the wireless power reception device and the information about the first charging range of the wireless power transmission device.

According to various example embodiments, the wireless power reception device may further include at least one sensor (e.g., the sensor module 340b), and the processor may be configured to: identify information about an orientation of the wireless power reception device using the at least one sensor, identify a relative location between the charging range of the wireless power transmission device and the wireless power reception device, based on the information about the location of the wireless power reception device, the information about the first charging range of the wireless power transmission device, and the information about the orientation of the wireless power reception device, determine a location and a form in which the first charging range is displayed on the display, based on the identified relative location, and control the display to display the first charging range, based on a determination.

According to various example embodiments, the processor may be configured to control the display to display the first charging range in at least a portion of the display, based on at least the portion corresponding to the first charging range.

According to various example embodiments, the processor may be further configured to control the display to display at least one object and/or a graphic effect corresponding to a direction of the first charging range on the display, based on the location of the wireless power reception device being outside a specified range corresponding to the first charging range.

According to various example embodiments, the processor may be configured to control the display to display a first object corresponding to the first charging range and corresponding to the wireless power reception device on the display.

According to various example embodiments, the processor may be configured to: control the at least one communication module to receive a third signal from the wireless power transmission device or an external device, and control the display to display a second charging range on the display, based on the third signal.

According to various example embodiments, the processor may be configured to control the display to display a second object corresponding to the second charging range and corresponding to the external device.

According to various example embodiments, the processor may be further configured to: identify a relative location between the first charging range of the wireless power transmission device and the wireless power reception device, based on a result of comparing the location of the wireless power reception device based on the wireless power transmission device and the first charging range, and determine a location in which the first icon indicating the location of the wireless power reception device is displayed, based on the identified relative location.

According to various example embodiments, the processor may be configured to: control the at least one communication module to receive a third signal from the wireless power transmission device or an external device, identify a charging state of the external device, based on the third signal, and control the display to display a fourth object corresponding to a location of the external device, based on the charging state of the external device.

According to various example embodiments, the processor may be configured to: identify information about a location of the wireless power transmission device based on the wireless power reception device, based on a third signal transmitted through the at least one communication module and a fourth signal received through the at least one communication module in response to the third signal, and control the display to display the first charging range, based on the information about the location of the wireless power transmission device and the information about the first charging range of the wireless power transmission device.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added.

Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method of operating a wireless power reception device, the method comprising:
identifying information about a location of the wireless power reception device with respect to a wireless power transmission device, based on a first signal received from the wireless power transmission device using at least one communication module of the wireless power reception device, the communication module comprising communication circuitry;
identifying information about a first charging range of the wireless power transmission device, based on a second signal received from the wireless power transmission device using the at least one communication module; and
displaying the location of the wireless power reception device as a first icon and displaying the first charging range as a line or a face on a display of the wireless power reception device, based on the information about the location of the wireless power reception device and the information about the first charging range of the wireless power transmission device.

2. The method of claim 1, further comprising identifying information about an orientation of the wireless power reception device using at least one sensor of the wireless power reception device,
wherein the displaying of the first charging range comprises:
identifying a relative location between the charging range of the wireless power transmission device and the wireless power reception device, based on the information about the location of the wireless power reception device, the information about the first charging range of the wireless power transmission device, and the information about the orientation of the wireless power reception device;
determining a location and a form in which the first charging range is displayed on the display, based on the identified relative location; and
displaying the first charging range on the display of the wireless power reception device, based on the determining.

3. The method of claim 1, wherein the displaying of the first charging range on the display comprises displaying the first charging range in at least a portion of the display, based on at least the portion corresponding to the first charging range.

4. The method of claim 1, further comprising displaying at least one object and/or a graphic effect corresponding to a direction of the first charging range on the display, based on the location of the wireless power reception device being outside a specified range corresponding to the first charging range.

5. The method of claim 1, wherein the displaying of the first charging range on the display comprises displaying a first object corresponding to the first charging range and corresponding to the wireless power reception device on the display.

6. The method of claim 1, further comprising:
receiving a third signal from the wireless power transmission device or an external device using the at least one communication module; and
displaying a second charging range on the display, based on the third signal.

7. The method of claim 6, wherein the displaying of the second charging range comprises displaying a second object corresponding to the second charging range and corresponding to the external device on the display.

8. The method of claim 1, further comprising:
identifying a relative location between the first charging range of the wireless power transmission device and the wireless power reception device, based on a result of comparing the location of the wireless power reception device with respect to the wireless power transmission device and the first charging range; and
determining a location in which the first icon indicating the location of the wireless power reception device is displayed on the display, based on the identified relative location.

9. The method of claim 8, further comprising:
receiving a third signal from the wireless power transmission device or an external device using the at least one communication module;
identifying a charging state of the external device, based on the third signal; and
displaying a second icon corresponding to a location of the external device on the display, based on the charging state of the external device.

10. The method of claim 1, wherein at least part of the at least one communication module is configured to support ultra-wideband.

11. A wireless power reception device comprising:
a display;
at least one communication module comprising communication circuitry; and
a processor,
wherein the processor is configured to:
identify information about a location of the wireless power reception device with respect to a wireless power transmission device, based on a first signal received from the wireless power transmission device using the at least one communication module;
identify information about a first charging range of the wireless power transmission device, based on a second signal received from the wireless power transmission device using the at least one communication module; and
control the display to display the location of the wireless power reception device as a first icon and to display the first charging range as a line or a face, based on the information about the location of the wireless power reception device and the information about the first charging range of the wireless power transmission device.

12. The wireless power reception device of claim 11, further comprising at least one sensor,
wherein the processor is configured to:
identify information about an orientation of the wireless power reception device using the at least one sensor; and
identify a relative location between the charging range of the wireless power transmission device and the wireless power reception device, based on the information about the location of the wireless power reception device, the information about the first charging range of the wireless power transmission device, and the information about the orientation of the wireless power reception device, determine a location and a form in which the first charging range is displayed on the display, based on the identified relative location, and control the display to display the first charging range, based on a determination.

13. The wireless power reception device of claim 11, wherein the processor is configured to control the display to display the first charging range in at least a portion of the display, based on at least the portion corresponding to the first charging range.

14. The wireless power reception device of claim 11, wherein the processor is further configured to control the display to display at least one object and/or a graphic effect corresponding to a direction of the first charging range on the display, based on the location of the wireless power reception device being outside a specified range corresponding to the first charging range.

15. The wireless power reception device of claim 11, wherein the processor is configured to:
identify information about a location of the wireless power transmission device with respect to the wireless power reception device, based on a third signal transmitted through the at least one communication module and a fourth signal received through the at least one communication module in response to the third signal; and
control the display to display the first charging range, based on the information about the location of the wireless power transmission device and the information about the first charging range of the wireless power transmission device.
